(19) United States
(12) Patent Application Publication
(10) Pub. No.: US 2013/0097581 A1
(43) Pub. Date: Apr. 18, 2013

(54) METHOD FOR RECORDING DATA, DEVICE, AND CORRESPONDING COMPUTER PROGRAM PRODUCT

(71) Applicant: Dominique Pere, Saint Gregoire (FR)

(72) Inventor: Dominique Pere, Saint Gregoire (FR)

(73) Assignee: POD PROGRAMMING, Montgermont (FR)

(21) Appl. No.: 13/641,428

(22) PCT Filed: Apr. 12, 2011
(86) PCT No.: PCT/EP11/55657

§ 371 Date: Dec. 26, 2012

(30) Foreign Application Priority Data
Apr. 15, 2010 (FR) 1052893
Jul. 23, 2010 (FR) 1056075

(51) Int. Cl. G06F 9/44

(52) U.S. Cl. CPC G06F 8/20
USPC 717/104

(57) ABSTRACT

The invention relates to a process for recording a plurality of data items constituting at least one entity.

According to the invention, such a process includes:
a phase of creating a data definition for each data item of said plurality of data items;
a phase of creating a relation definition for at least one relation between at least two previously created data definitions;
a phase of creating each data item and relation of said plurality of data items;
a phase of recording each data item of said plurality of data items so that a recorded data item is associated with a corresponding data definition;
a phase of recording at least one relation so that a recorded relation corresponds to a relation definition and is associated with at least one previously recorded data item.

### FIELD OF THE INVENTION

This invention relates to the field of data management.

This invention relates more specifically to the management of data by software applications.

The field of the invention is included in the field of implementing development frameworks suitable for the creation of software applications. Such development frameworks are generally called frameworks. In computer programming, a framework includes a set of structural software components, which define the foundations as well as the major lines of the organization of all or part of a software program (architecture). In object-oriented programming, a framework includes more specifically a set of parent classes that will be derived and extended by inheritance on the basis of needs specific to each software program that uses the framework.

With the increase in functionalities offered by the programming languages, frameworks have become key parts in the development of software applications. Among the numerous existing frameworks, it is possible to cite “Qt”™ for C++ language, Spring™ for Java language and Symfony™ for PHP language. This list is far from being exhaustive. Many frameworks are created every day by groups of developers depending on the needs they encounter.

To summarize, it can be stated that, as a general rule, a framework corresponds to a particular vision of the way in which a resulting software application should be structured and a particular vision of how the development of a software application should be conducted.

### SOLUTIONS OF THE PRIOR ART

Computer application development projects benefited in the 1970s from the Merise method, which provided an integrated framework for analysis of design and production of computer systems, making it possible in particular to formalize the structure of data. Then, in the 1990s, the UML method provided a framework for modelling classes for the design of object-oriented applications. The application development frameworks developed and used today are based on these methods and therefore follow a model-oriented software engineering (MDE: model-driven engineering). In spite of the current profusion of MDE frameworks, data management in the broad sense is a problem in software development. The structure, integrity, persistence, entry, display, import, export, interfacing, and synchronization of data are problems common to all software programs that manipulate data.

The prior art of development support tools shows that there are various MDE framework solutions that offer the possibility of generating data. Some of them offer the possibility of generating, from a single description file, a database and classes making it possible to manipulate this data, optionally on the basis of a so-called “business” approach, when the description file is capable of taking these aspects into account. Although such application source code generating methods are beneficial, the fact remains that they do not make it possible to optimally manage data.

Indeed, the data structures are too rigid and disconnected from the upper application layers (layers manipulating the business objects). This involves:
the appearance of impedance abnormalities (“object-relational impedance mismatch”), due to the fact that the current framework storage layers mimic the data model, when the DBMS used (Oracle, MySQL for example) does not make it possible to express the integrity constraints of the object layer (public/private accessibility of attributes interface, concept of interface, inheritance, polymorphism, granularity of data modifications, relations developed between data—at 3 ends, some obligatory and others optional—, navigability of a relation between data, etc.);
the need to “break” the application when the data model changes, for example when it is necessary to create a new data item or a new entity representing an existing or non-existing data set;
the re-expression of the new model of data that have evolved in all of the application layers.

Thus, ultimately, the benefits initially provided by the use of a development framework are lost when it is necessary to modify the data model and the corresponding database structure. In other words, the current methods do not take into account the natural change in data structures over time, and it is still necessary to modify the application layers of the application in depth when the data model changes. This is due primarily to the way in which the data is recorded in the data recording structure.

The invention enables these problems associated with the prior art to be solved by providing a data recording method that does not have these disadvantages of the prior art.

### SUMMARY OF THE INVENTION

The invention does not have these disadvantages of the prior art. More specifically, the invention relates to a process for recording data intended to be used in the framework for development and maintenance of software applications. According to the invention, this process includes a phase of defining data—and relations linking it—and a phase of managing this data separately. According to the invention, each data item is identified and independent like an entity (table or class) and can therefore be linked with any other data item. By comparison with the traditional “entity” approach in which the data items are final values, the decapsulation of the data makes it possible for the developer to create a business class from each data item of the object model. The invention leads to a new paradigm for describing the data model, which, by being mutualised through the different layers of the application (storage, object model, view, etc.), makes it possible to eliminate the problems of inadequate impedance.

In other words, the invention results in a destructurization of the data recording so as to process it and change its organization more easily. The invention thus makes it possible to:
limit cases of so-called “breaking” updates of the data model;
automate the storage, generation of views and other functionalities that are based on the data model (statistics, import-export, etc.).

The invention goes against the prior art techniques since, instead of combining the data so as to make it more accessible more quickly, it organizes data independently. The recording of data, as such, is independent of any database: the recording can be performed in a so-called “flat” file, in an XML document or in a traditional relational database. The important point, from the perspective of the invention, is for the structure for storing the recorded data not to be dependent on the data structure. For example, the data constituting a contact (surname, name, address) will not be placed in a single recording, in a tabular form, but may be recorded, for example, in independent tables.

More specifically, the invention relates to a process for recording a plurality of data items constituting at least one entity.

According to the invention, such a process includes:
a phase of creating a data definition for each data item of said plurality of data items;
a phase of creating a relation definition for at least one relation between at least two previously created data definitions;
a phase of creating each data item and relation of said plurality of data items;
a phase of recording each data item of said plurality of data items so that a recorded data item is associated with a corresponding data definition;
a phase of recording at least one relation so that a recorded relation corresponds to a relation definition and is associated with at least one previously recorded data item.

According to a particular embodiment of the invention, said phase of creating a relation definition includes, for a relation:
a step of creating a first relation end including a first relation cardinality and associated with a first data definition;
a step of creating a second relation end each including a cardinality of relation associated with a data definition.

According to a particular feature of the invention, a data definition includes:
a code name;
a type.

According to a particular feature of the invention, a relation definition includes:
a code name;
a type;
at least one end.

According to another aspect, the invention relates to a device for recording a plurality of data items constituting at least one entity. According to the invention, such a device includes:
means for creating a data definition for each data item of said plurality of data items;
means for creating a relation definition for at least one relation between at least two previously created data definitions;
means for creating each data item and relation of said plurality of data items;
means for recording each data item of said plurality of data items so that a recorded data item is associated with a corresponding data definition;
means for recording at least one relation so that a recorded relation corresponds to a relation definition and is associated with at least one previously recorded data item.

According to another aspect, the invention relates to a computer program that can be downloaded from a communication network and/or stored on a computer readable medium and/or run by a microprocessor, characterized in that it includes program code instructors for executing the recording process as described above.

### LIST OF FIGURES

Other features and advantages of the invention will become clearer in view of the following description of a preferred embodiment, provided solely as an illustrative and non-limiting example, and the appended drawings, wherein:

FIG. 1 shows the principle of data management according to the invention;

FIG. 2 shows the data management core according to the invention;

FIG. 3 is a diagram of the classes manipulating the data model in an embodiment of the invention;

FIG. 4 is a UML diagram of the classes manipulating the content in an embodiment of the invention;

FIG. 5 describes a simplified version of the interfaces declared to manage the database abstraction layer in an embodiment of the invention;

FIG. 6 is a physical model of the storage tables resulting from an example for implementing the invention;

FIG. 7 shows examples of models constructed with the modeller of the invention.

### DETAILED DESCRIPTION OF THE INVENTION

### 1. Summary of the Principle of the Invention

The observation addressed by the prior art is that the entities (tables of databases and business classes) are “boxes” that produce rigidity with regard to the evolution of the application. The idea underlying the invention is to break the principle of entity so as to make each element independent (data field or business class attribute), and to link them by means of relations so as to form a data model that is, moreover, defined in a mutualised manner for all of the layers of the application.

### 2. Means Implemented in the Context of the Invention

The implementation of the principle presented requires a plurality of technical processes to be implemented:
the atomisation of data;
the appropriation of the data model by the application;
a storage structuring independent of the data model.

### 2.1 Atomisation of Data

Whether they are structured in hierarchical, tabular or relational form, the information manipulated by any system may be described with data and relations. In the context of the invention, these two concepts have been defined as follows:
data item: represents an atomic element of information (for example, property or field). A data item is identified by a code name and a value;
relation: links one or more data items (a data item may be linked to itself).

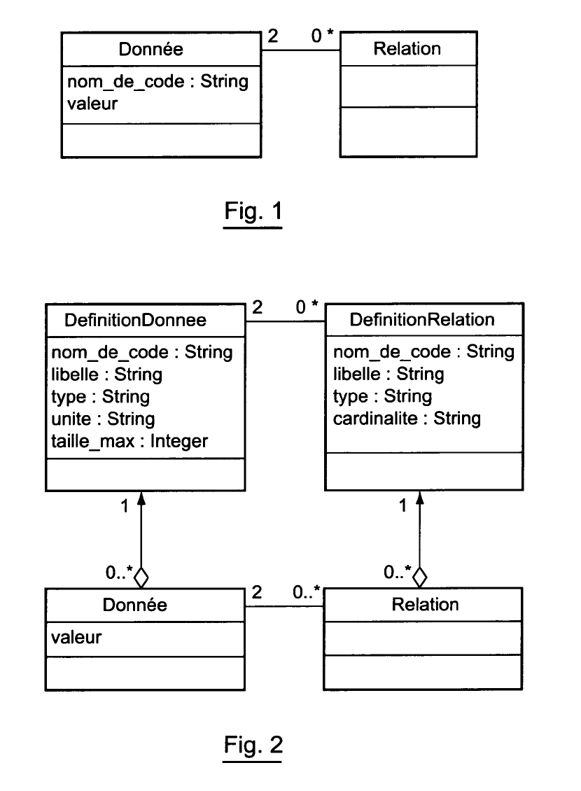

Because of its atomic character, a data item according to the invention is monovalued and non-decomposable (FIG. 1).

A data item can be isolated or be connected to an indefinite number of data items by relations. A relation links at least two data items to one another. The description of the relation is simplified in the diagram of FIG. 1, but it may be qualified by a semantic type in the UML sense (reference, aggregation, composition, inheritance), but also by the designer of the application by: a relation code name, the role played by each end of the relation.

Thus, the data set may be comprised of different data of the contact code name, each associated with its respective name and surname data, with the associations being materialized by relations.

### 2.2 Appropriation of the Data Model by the Application

Since the data and the relations make it possible to construct the data set manipulated by the application and to modify it as desired, it is necessary for a data management application to define the data model for it so that the application “knows” what it is manipulating.

The functioning caused by the implementation of the invention makes it possible to describe the data model by means of data definitions and relation definitions. The model is described a single time in the core of the application, eliminating the need to re-express its structure and its constraints in all of the application layers.

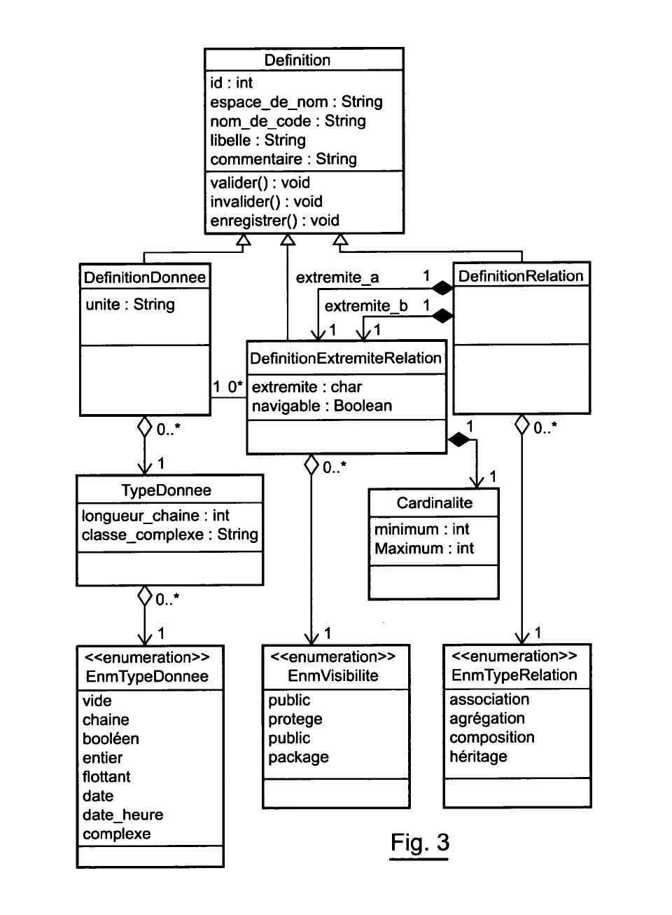

Thus, the inventor had the idea of adding two concepts corresponding respectively to the above concepts (FIG. 2):
data definition: declares a data item with a code name (for the application) and optional description (intended for the user display), specifying its type (string, numeric, Boolean, etc.), its maximum size, etc.
relation definition: declares a possible relation between at least two data definitions with a code name, optional description, the type and cardinality of the relation (in the UML sense) for each of the data definitions.

The definitions describe the data model manipulated by the application, but they do not have any knowledge of the existing data during use of the application. However, each data item knows:
its relations with the other data items of the data set manipulated;
its data definition, and consequently the types of relation possible with the other data items (via the relation definitions).

FIG. 2 simply shows the strong couplings between the model and the data set. We will show in the preferred embodiment of the invention that the relation ends (each of the two linked data definitions) can be characterized in greater detail according to:
its navigability (yes, no): does a data item know the data items with which it is linked?
its visibility: in the case of a composition relation (1-0.1), the linked data item may correspond to a “public”, “protected” or “private” attribute.

### 2.3 Structure of the Independent Storage of the Model

Unlike MDE persistence engines (ORM approach, i.e. use of the object-relational mapping, data object-entity), the storage engine of the invention manipulates only the four concepts defined above (data definition, relation definition, data and relation). The structure of this storage engine does not therefore have any need to change in order to follow the changes in the data model. The modification of the data model according to the invention involves a modification of data and relation definition recordings, while the modification of the data set involves the modification of data and relation recordings.

### 3. Advantages of Implementation of the Invention

Each data item is identified and independent like an entity (table or class) and can therefore be linked to any other data item:
this drastically limits the cases of “breaking” updates of the data model
the storage and other functionalities based on the data model can be automated (statistics, import-export, etc.).

Below, an embodiment of the invention will be presented. It is clear, however, that the invention is not limited to this particular application, and that it can also be implemented in many other fields.

### 4. Description of an Embodiment

This embodiment presents a possible implementation of:
the core of the architecture;
the module for storing content (data and relations) and the model (definitions);
the module for interfacing with business classes;
the module for generating statistics;
the import/export module;
the synchronization module;
the modeller (view and manipulation of the model);
the data explorer (view and manipulation of data).

The platform chosen for this implementation is as follows:
language: PHP (server side), html/JavaScript (IHM client side)
HTTP server: Apache;
database: MySQL, InnoDB engine.

Of course, any other implementation in another object-oriented language is possible, as the invention can be applied to any data management application, wither in a web context or not.

### 5. The Architecture Core

### 5.1 The Data Model

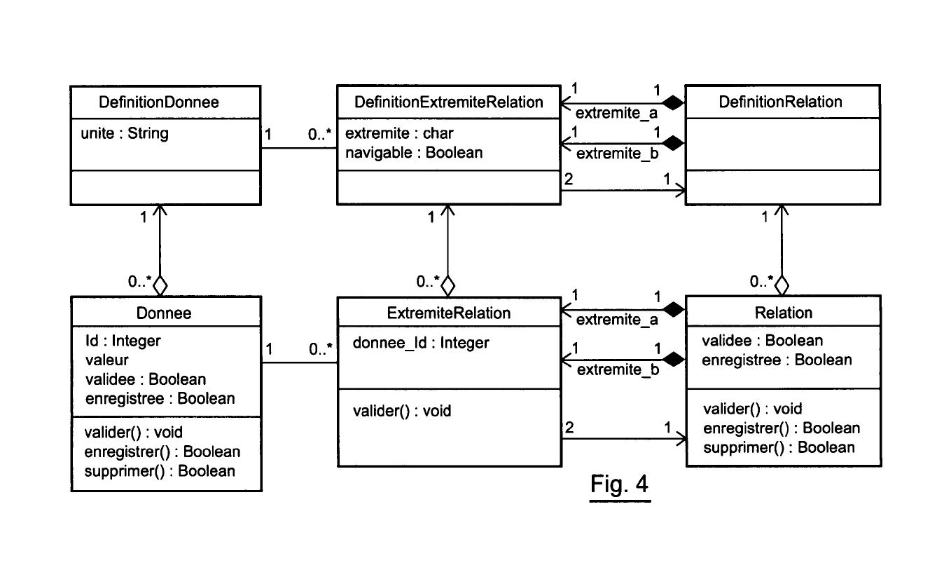

In reference to FIG. 3, we will present the diagram of classes manipulating the data model in this embodiment of the invention: the data and relation definitions.

### 5.1.1 Definition

The concept of Definition is mutualised between a data Definition, a relation Definition and a relation end definition:
a definition is identified by an id (auto-incremented number, assigned and used by the storage module);
the name space is a code string indicating the business domain of the definition. Examples: “crm”, “real_estate”, “financial”, “math”. It must be in lower case, without spaces and begin with a letter.
the code name, unique within a name space, identifies the definition. Examples “contact” (for crm), “house” (for real_estate), “debit” (for financial), “digit” (for Math). The code name is systematically used in the program to manipulate the definitions and the instances corresponding to these definitions (data, relations and relation ends). It must be in lower case, without spaces and begin with a letter.
description and comments are present only for the purpose of auto-documentation of the model, in the language of the designer. The multi-language display is managed in the “view” layer.

### Data Definition

A data definition can be compared to an entry in a data dictionary except that it does not belong to any entity (or table in a database). The data definition gives a framework to the content, i.e. to the data values accepted in an information system.

It inherits the concept of Definition and is materialized with:
a type of data that can be simple (chain, Boolean, etc.) or complex (represented by a dedicated class). The list of simple types presented in the diagram is not exhaustive (example: long integer, short integer, double, etc.). The void type makes it possible to manage data that cannot be expressed as a simple value (example: a contact can describe only one data item, and will therefore be materialized by composing other data items such as surname and name, insofar as it is desirable to manipulate these to information items separately).
a length (to mark off the string type).
a class name (specifies that class to be used for the complex types).
a unit (for numeric types). Used for the purpose of auto-documentation of the model in the language of the designer. The multi-language display is managed in the “view” layer.

### 5.1.2.1 Example of Data Definition

This data item represents the sales figure of a company.
name space: crm;
description: sales figure;
comment: annual sales figure in euros;
type: integer;
unit: C.

### 5.1.3 Relation Definition

A relation definition establishes a relationship between two data definitions. It frames the possible relations in an information system. The choice was made, in this embodiment, to be limited to the binary relations in order to require the designer to create an entity (in this case a data definition) at the union of the relation. This is perceived as a better practice because a data definition is more changing than a relation definition. However, the system may just as easily manage the n-area relations (including at the storage level).

A relation definition therefore has two ends referred to as A and B. Each end points to a data definition. The relation definition is typed reusing the UML terms:
association: simple relation between two data definitions, without interdependency;
aggregation: non-symmetrical association, which expresses a strong coupling and a subordination relation (set/element). In this type of relation, A is the aggregate and B is the aggregate;
composition: strong aggregation in which the life cycle of the components is linked to the compound, a compound can have only one component. In this type of relation, A is the component and B is the compound;
inheritance: enables a data item B to inherit relationships defined in a data item A. In this type of relation, B specializes A and must have a data definition of the same type as A. If A is a complex type (class), the complex type of B must be a class inheriting the complex type of A.

It is noted that, contrary to the purely semantic subjectivity produced by UML at the level of the aggregation- and composition-type relations, the invention uses them in its different modules so as to deduce the appropriate behaviours at the level of the storage, the persistence, the generation of the business objects, the IHMs and so on.

The relation ends complete the relation definition by giving:
the concept of navigability, which responds to the question: “Does A know B” and vice versa. By default, a relation is navigable in both directions. Example: if “navigable” is “false” on side A, then a data item corresponding to the data definition on side B cannot run through relations leading to data items corresponding to the data definition on side A. In other words: any data item on side B cannot know the data on side A (the Bs simply ignore the existing relations).
the data visibility corresponding to the end:

private, protected, public. This is useful in modules for generation of business objects (visibility of accessors), IHM (data that can be displayed), statistics, etc.
the code name is in this case especially useful for qualifying the end of the relation, in the sense of the “role” in UML. This is useful for navigating from one data item to others without necessarily naming the relation.
the cardinality indicates the minimum and maximum number of data instances of this end, which can be correlated with a data item of the opposite end.

### 5.1.3.1 Example of Relation Definition

With two data definitions “Company” and “Contact”, the following relation definition is declared:
name space: crm;
code name: contact_works_company;
description: works;
comment: relation indicating the contacts who work at a company;
type: association;

### Definition of End A

name space: crm;
code name (defines the role): used (because from the perspective of the company, the contact is an employee);
description: employee;
comment: indicates the contacts employed by this company (optional);
end: ‘A’;
data definition: Contact (Instance of the corresponding class definition);
navigable: yes (a company can indeed access its employees);
visibility: public;
cardinality min: 0 (A company does not necessarily have employees);
cardinality max: null (no maximum limit on the number of employees);

### Definition of End B

name space: crm;
code name (defines the role): employer (because of the perspective of the employee, the company is his or her employer);
description: employer;
comment: indicates the company that employs this contact (optional);
end: ‘B’;
data definition: Company (Instance of the corresponding class Definition);
navigable: yes (a contact can indeed access the company in which it works);
visibility: public;
cardinality min: 0 (if a contact does not systematically work at a company);
cardinality max: 1 (if a contact can work only at a maximum of one company;

### 5.1.4 Declaration of the Model

In this embodiment of the invention, the model must be declared in the form of a script creating the data and relation definitions. After the script, these definitions are recorded in the database. This script is to be run only when the model is to be modified.

It is nevertheless possible to create an XML schema for the declaration of the model, derived from XMI so as to be adapted to the paradigm of the invention.

Ultimately, the easiest tool for declaring and manipulating the model with a graphic interface will be the modeller.

Whatever the case may be, during initialization of the program, the definitions are read in the database and kept in the memory. Unlike in MDA approaches, the model is not therefore used only to generate the code but it veritably constitutes the core of the application.

### 5.2 The Data (Content)

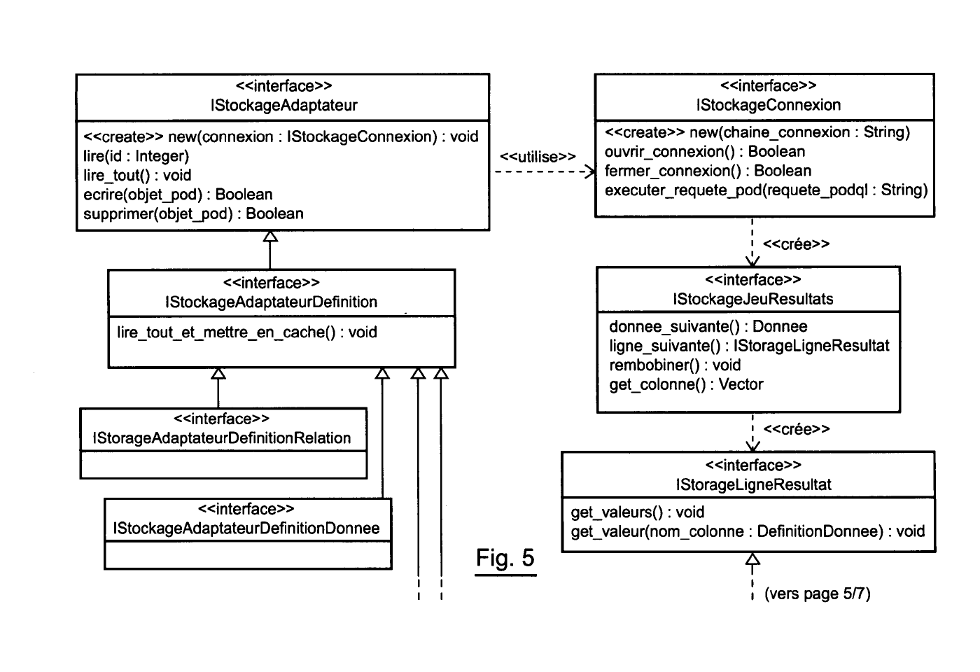

In reference to FIG. 4, we will present the UML diagram of the classes manipulating the content: Data and relations. The definition objects to which the objects receiving the content are connected are placed there as a reminder.

### 5.2.1 Data Item

A data item can simply be expressed by a data definition (which gives the context) and a value (which gives the content).

### 5.2.1.1 Id

This is an auto-incremented, assigned number used by the storage module. Each data item has a unique number for its data definition. This gives it its independence and its capacity to change, enabling it to be linked to any other data item by the establishment of relations. This attribute is void if the data item has not yet been recorded.

### 5.5.1.2 Data Definition

A data item is connected to one and only one definition. This definition gives it its context for existence and validation.

### 5.5.1.3 Value

The characteristic of a data item is its value: this is variable, depending on the type of data definition. When a value is modified, the data item is noted as being non-validated and non-registered.

### 5.2.1.4 Validate( )

Uses the data definition to verify whether the value corresponds to the type defined. Asks each relation to validate itself, then verifies that the cardinalities declared in the definitions of the relation ends are respected (min and max). The data item is then noted as validated (to avoid its revalidation in a subsequent call).

Example: A and B are two data definitions, respectively: “Contact” and “Name” having in common a relation definition with, on side B, the cardinality “min=1” and “max=1”. Under these conditions, a data item of the “Contact” definition, which is not linked to exactly one data item of the “Name” definition will be declared as non-valid.

### 5.2.1.5 Record( )

Validates the data and, if successful, delegates its recording to the storage layer. If the value is void even though its definition specifies a non-void type, the data item is deleted. This ensures that only consistent data, i.e. secured with a value, are managed. The data item is then noted as recorded so as to prevent its re-recording in a subsequent call.

### 5.2.1.6 Delete( )

Deletes the relations linked to the data item, then deletes the data item. The deletion of relations has the effect of deleting, in a cascade, the data in the in the context of a composition or inheritance relation (cf. deletion of a relation).

### 5.2.1.7 Example of Data Item

Let us consider “Pod programming” to be a company. It is declared as follows:
data definition: Company (Instance of the corresponding Definition class, string type)
id=1 (this company was the first recorded in the information system)
value=“Pod programming”

### 5.2.2 Relation

A relation joins two data items in the context of a relation definition. Like the latter, it has two relation ends referred to as A and B. It is noted that a relation is not necessarily limited to two ends and that it is entirely possible to implement n-area relations.

### 5.2.2.1 Validate( )

Calls the validate ( ) method on each of the ends, then marks the relation as validated.

### 5.2.2.2 Record( )

Calls the validate ( ) method then, if successful, records the relation. If a data item at one end does not have an id, its recording is first requested. If this relation is of the composition type, a call to record( ) on the data on side B is made. The relation is then noted as recorded so as to prevent its re-recording in a subsequent call.

### 5.2.2.3 Delete( )

Deletes the relation. If this relation is a composition relation, deletes, in a cascade, the data item on side B. If this relation is of the inheritance type, deletes the data at the ends of the relation.

### 5.2.2.4 RelationEnd (End a and End b)

Each relation end is connected to the corresponding relation and to a data item. A data item can be assigned to an end only if its data definition corresponds to that declared in the definition of the corresponding relation end. This ensures the integrity of the relations.

When a relation end is modified, the corresponding relation is noted as validated and non-recorded.

The property “data_id” is useful for managing the delayed instantiation, i.e. not systematically instantiating the data at the two ends of a relation. The corresponding data is therefore instantiated only in its first call.

### 5.2.2.5 Example of Relation

Let us consider two data items “Pod programming” and “Dominique Péré” corresponding respectively to the data definitions “Company” and “Contact”; the following relation is declared:
relation definition: works (instance of the corresponding class “RelationDefinition”, defined above)
end A:
   data item: Instance of the class “Data” corresponding to “Dominique Péré”, of id 1, with the data definition “Contact”
   data_id: 1
end B:
   data item: Instance of the class “Data” corresponding to “Pod programming”, of id 1, with the data definition “Company”
   data_id: 1

### 6. Storage Module

### 6.1 Storage

The database chosen is MySQL with the storage engine InnoDB for its relational and transactional capacities. The storage of data and relations (content) are distinguished from the storage of definitions (model).

It should be noted that the storage layer may be implemented entirely differently by implementing the dedicated interfaces. The core of the framework of the invention uses only interfaces. A simple parameterization of the application (storage engine and connection string) makes it possible to go from one storage layer to another. In addition, a single storage layer implemented with the PDO objects (“PHP Data Objects”) makes it possible to disregard the database actually used.

### 6.1.1 Declared Interfaces

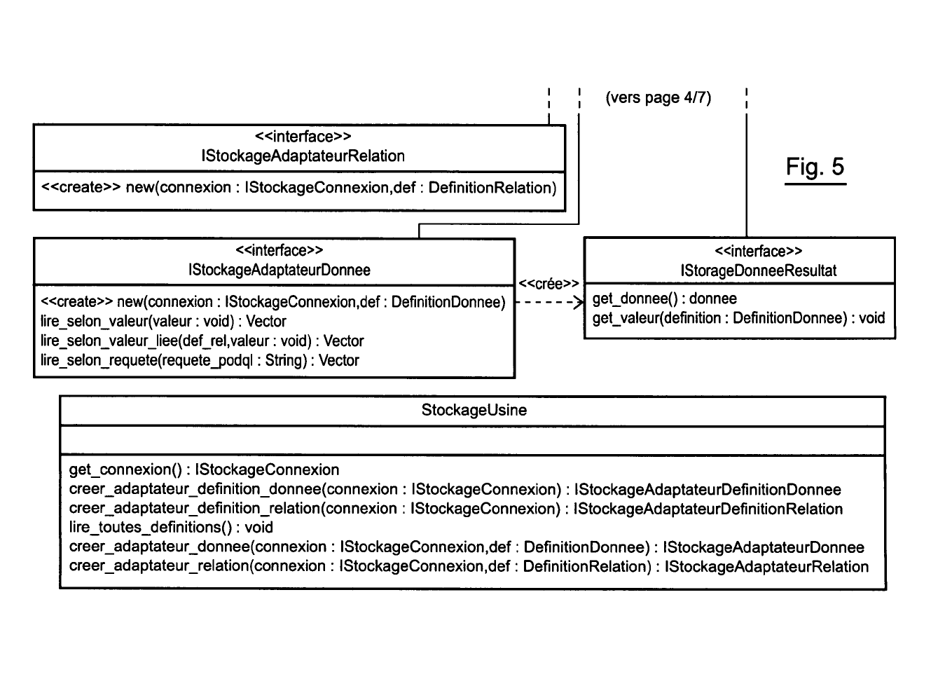

A simplified version of the declared interfaces for managing the abstraction layer at the database is presented below in reference to FIG. 5.

### 6.1.1.1 IStorageConnection

Represents a connection to a database. This class declares the methods making it possible to open and close a connection. It also makes it possible to run a request in PodQL (derived from SQL language adapted to the framework of the invention). All of the objects accessing the storage use it to obtain the connection or run the PodQL.

A PodQL request returns an object implementing the IStorageResults interface, which can be run through like a “fetch” to explore the result. Each result line (IStorageResultLine) expresses the values returned, indexing by relation end data definition code name on the basis of the request made (cf. PodQL section for more details on its operation).

### 6.1.1.2 IStorageAdaptor

The IStorageAdaptor and inheritances interfaces define the adaptors to be implemented in order to be capable of reading and recording the objects of the framework of the invention: “DataDefinition”, “RelationDefinition”, “Data” and “Relation”. They make it possible to create an adaptor on a given connection and to read, write and delete any object from the database.

The interfaces manipulating the data and relations also make it necessary to specify which data or relation definition is concerned.

### 6.1.1.3 IDatatStorageAdaptor

This adaptor is the most important because it manages all instantiations (readings) of data. The reading by id obviously cannot suffice. It is at this level that it can be specified which data to read on the basis of its value or the value of other data directly related to it (method read_accordingto_value). For more complex cases, the where clause of a request is written in PodQL (method read_accordingto_request).

### 6.1.2 Structure of the DBD for MySQL

For the implementation in MySQL/InnoDB in this embodiment, a DBD structure with one table per data definition and one table per relation definition, each storing the data and relation values, is proposed.

Each data table is named with the id of the data definition and secured with an id and a value. The id is an auto-incremented integer, a primary key of the table.

Each relation table is named with the id of the relation definition and secured with an id, the id of the data item of end A and the id of the data item of end B. The id is an auto-incremented integer, a primary key of the table. The fields data_a_id and data_b_id are indexed on two distinct indices, making it possible to optimize the joins with the relation tables. Finally, a referential integrity is activated between each foreign relation key and each data id, ensuring that the two ends of a relation refer to existing data, with updating and deletion in cascade.

As an example, we will consider the following data definitions:

1. contact: id=“1”, code_name=“contact”, type=“void”

2. surname: id=“2”, code_name=“surname”, type=“string”, length=“50”

3. name: id=“3”, code_name=“name”, type=“string”, length=“50”

4. company: id=“4”, code_name=“company”, type=“string”, length=“50”

We will consider the following relation definitions:

5. surname of the contact: id=“1”, code_name=“contact_surname”, type=“composition”, end_a=“1”, end_b=“2”

6. name of the contact: id=“2”, code_name=“contact_name”, type=“composition”, end_a=“1”, end_b=“3”

7. company of the contact: id=“4”, code_name=“contact company”, type=“association”, end_a=“1”, end_b=“4”, role_end_a=“employee”, role_end_b=“company”

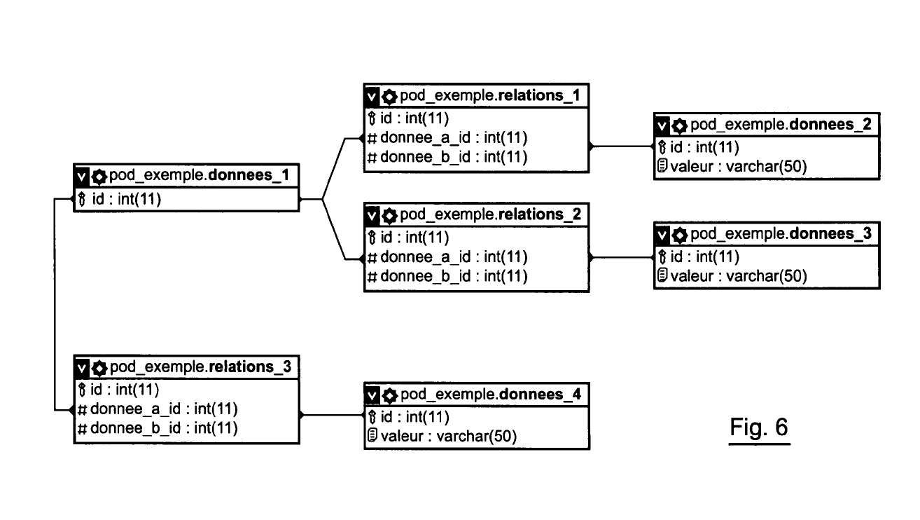

This is the physical model of the storage tables derived therefrom and presented in reference to FIG. 6.

The names of the data tables are prefixed with “data” followed by the id of the corresponding data definition. The data corresponding to the data definitions (noted after DD) contact, surname and name are therefore respectively stored in data_{—}1, data_{—}2 and data_{—}3. It is noted that data_{—}1 does not have a “value” field because the “contact” data definition specifies a void type. Conversely, data_{—}2 and data_{—}3 have a “value” field of the varchar(50) type corresponding to the data definition type.

In the same way, the names of the data tables are prefixed with “relations_” followed by the id of the corresponding relation definition. The table “relations_{—}1” links a contact to its surname and “relations_{—}2” links a contact to its first name.

It should be noted that these tables are created automatically, if necessary, when initializing the application, in view of the existing data definitions.

### 6.2 PODQL

In view of the description of the physical structure of the DBD, it can be seen that requests on this data structure are particularly tedious to perform in SQL, because of the explosion of data, the naming of the tables and the large number of joins to be performed (running through the relations)

### 6.2.1. Automated Joins

We will therefore describe a request language derived from SQL, enabling the physical structure of the database to be overlooked. The main benefit of PodQL is that joins are automated. The value data to be obtained are expressed on the basis of the code name of the data item or the role name with respect to a central data item. Owing to this request translation and the fact that the framework of the invention “knows” the data model, the expression of the “FROM” clause as well as traditional joins are spared, purely and simply.

The concept of an operator running through relations, noted “→” (a hyphen followed by the greater than sign, representing an arrow).

We will present two explanations with the example of the use of the PodQL as interpreted by the “MySQLConnection.execute_request_pod( )” method which implements “IStorageConnection.execute_request_pod( )”.

6.2.1.1 Example of Select with Values

Using the data and relation definitions provided in the description of the DBD structure for MySQL, we will consider it desirable to perform a request that gives the contacts of the “Pod programming” company. The request in PodQL will be as follows:

SELECT contact->surname, contact->name WHERE contact->employer=‘Pod programming’ ORDER BY contact->surname

In this case, “contact” is considered to be the central data, and the other data are expressed as a relation on this basis.

The above request is translated into SQL, in our physical implementation described above, as follows:

SELECT data_{—}2.value AS ‘contact->surname’, data_{—}3.value AS ‘contact->name’

FROM data_{—}1, data_{—}2, data_{—}3, data_{—}4, relations_{—}1, relations_{—}2, relations_{—}3

WHERE data_{—}1.id=relations_{—}1.data_a_id AND relations_{—}1.data_b_id=data_{—}2.id
AND data_{—}1.id=relations_{—}2.data_a_id AND relations_{—}2.data_b_id=data_{—}3.id
AND data_{—}1.id=relations_{—}3.data_a_id AND relations_{—}3.data_b_id=data_{—}4.id
AND data_{—}4.value=‘Pod programming’

ORDER BY data_{—}2.value

Comment: The order of the elements in the “where” clause is not a matter of concern because MySQL automatically plans the request and determines the optimal execution order.

6.2.1.2 Example of Select with Id and Grouping

This is another example that makes it possible to account for the number of employees per company:

SELECT company, count(company->employee.id) AS nb_employees

GROUP BY company

Here, the use of the operator is noted “.” (in company→employee.id), indicating a field of a table as in traditional SQL. By default, it is the value that is returned, but here, the value of a contact data item does not exist. The application of the “.id” makes it possible to specify that it is desirable to obtain the id in this column.

The above request is translated into SQL, in our physical implementation described above, as follows:

SELECT data_{—}4.value AS ‘company’, count(relations_{—}3.data_a_id) AS nb_employees

FROM data_{—}4, relations_{—}3

WHERE data_{—}4.id=relations_{—}3.data_b_id

GROUP BY data_{—}4.value

The PodQL detects here that, with regard to the table data_{—}1, only the id is requested. It therefore prevents the join of relations_{—}3 to data_{—}1 not providing any useful additional information.

### 6.2.2 Series Instantiation

It was seen that PodQL could return values and data identifiers by automating the joins. Another of its benefits is that it can instantiate, in a string, data corresponding to different data definitions, preventing a request from being carried out on the basis of data in each relation run-through.

By default, the relation types defined above are used. Upon the instantiation of any data item having aggregation- or composition-type relations of which it is the aggregate, the “string” instantiation of the data is produced.

However, this default behaviour can lead to the reading of too much data or not enough data depending on the context of use. Consequently, the method MySQLAdaptatorData.read_accordingto_request( ), which implements IStorageAdaptorData.read_accordingto_request( ), makes it possible to interpret a PodQL request specifying the data to be returned (SELECT) by managing the instantiation of all of the data and relations concerned. The columns returned are therefore no longer only the values but also the id's and data and relations to be instantiated on the basis of the result of the request.

We will consider the example of the search for employees at the “Pod programming” company.

SELECT contact->surname,

contact->name

WHERE contact->employer=‘Pod programming’

ORDER BY contact->surname

The method MySQLAdaptatorData.read_accordingto_request( ) will generate, line-by-line, the following SQL code:

SELECT data_{—}1.id AS data_{—}1_id, relations_{—}1.id AS relations_{—}1_id, data_{—}2.id AS data_{—}2_id, data_{—}2.value AS data_{—}2_value,

relations_{—}2.id AS relations_{—}2_id, data_{—}3.id AS data_{—}3_id, data_{—}3.value AS data_{—}3_value

FROM data_{—}1, data_{—}2, data_{—}3, data_{—}4, relations_{—}1, relations_{—}2, relations_{—}3

WHERE data_{—}1.id=relations_{—}1.data_a_id AND relations_{—}1.data_b_id=data_{—}2.id

AND data_{—}1.id=relations_{—}2.data_a_id AND relations_{—}2.data_b_id=data_{—}3.id

AND data_{—}1.id=relations_{—}3.data_a_id AND relations_{—}3.data_b_id=data_{—}4.id

AND data_{—}4.value=‘Pod programming’

ORDER BY data_{—}2.value

Only the SELECT clause was modified with respect to the previous example. Its interpretation by “MySQLAdaptatorData” makes it possible to instantiate, for each corresponding contact:
the ‘contact’ definition data
the ‘contact_surname’ definition relations linked to the contact
the ‘surname’ definition data linked to the ‘contact_surname’ relations
the ‘contact_name’ definition relations linked to the contact
the ‘name’ definition data linked to the ‘contact_name’ relations

Owing to this process, a single request was made of the database, enabling all of the data and relations concerned to be instantiated.

### 6.2.2.1 Operator “*”

To further simplify the process of creating data in series, the operator “*” is introduced into the SELECT clause, already present in SQL, in order to translate it into its equivalent in PodQL as follows: “A→*” is equivalent to all data B linked to a data item A by a composition relation, of which A is the compound.

Thus, given that “contact_surname” and “contact_name” are composition relations, the following two PodQL requests are similar and will produce the same SQL code:

SELECT contact->*;

SELECT contact->surname, contact->name;

1.1 Modeller

Based on UML, the modelling with the framework according to the invention is very similar to the class diagrams, with just a few differences. The differences are as follows:

1. data definitions, not classes, are represented, with bubbles.

2. the data definitions contain a unique property: the value (to be typed)

3. the data definitions do not contain methods (or operations)

However, the UML relations are similar in every way to the definitions of relations of the framework of the invention.

As the concept of property no longer exists, everything must be modelled as data and relation definitions, as if an object model were modelled by being constrained to each property being a business object.

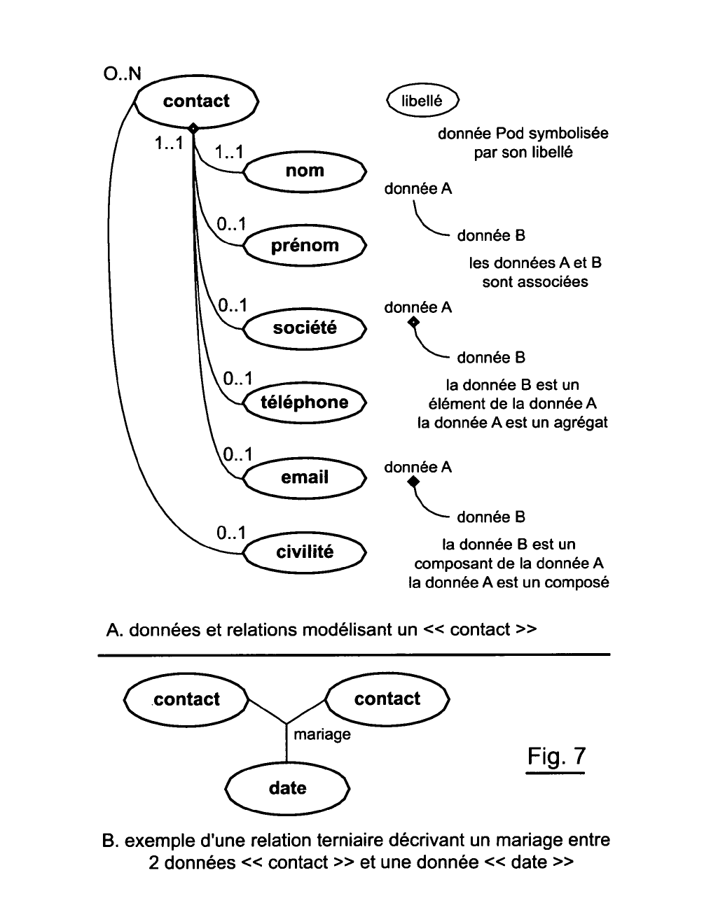

FIG. 7 shows examples of models constructed with the modeller.

Once the model is validated, the modeller proposes the following functions:
the generation of the XMI file representing the model
the generation of PodQL instructions necessary for duplication (in the case of the passage of a relation cardinality from 0 . . . 1 to 0 . . . N)
the generation of PodQL instructions necessary for causing a relation to migrate to a data item. Example: relation ‘is_married_to’; between two ‘person’ data definitions; which becomes a ‘marriage’ data item, then enabling it to be qualified by date, location, etc.
   5.8 Module for Interfacing with Business Classes

The invention proposes the possibility of interfacing with an existing application, from the time that it is programmed as an object. To do this, a “data” definition corresponding to each class to be interfaced is declared as a complex type and by giving it the name of existing class.

Each class to be linked to the framework of the invention must encapsulate a “data” property and implement the interface IContainerData, which defines the following methods:
get_data: returns the data object corresponding to the data item
set_data: assigns a data item to the “data” property
get_id: returns a unique identifier of this instance. This id is stored in DBD in the value field of the corresponding data table de la table
record: makes it possible to record both the instance in progress and the data encapsulated
delete: deletes the instance in progress and the data encapsulated
Instantiate(id) (static method): makes it possible to instantiate an instance of this class on the basis of an id, as well as to instantiate and assign the data item corresponding to the encapsulated “data” property.

As with the generated classes, the user can generate, with the modeller, a series of accessors in this class so as to be capable of accessing the values, data (and objects) directly linked to the data, without needing to interrogate the relations of the encapsulated data. This code is generated at the end of class in a reserved zone and regenerated as the case may be in this same zone.

### 5.9 IHM Module

The model used by the interface is the data model described above:
knowledge of the data model+definitions: entry control
dynamic generation (also possible on execution) of display/entry screens adapted to the model
automated entry control: explain how this works

Options for generation (for each screen):
declaration of the central DD (displayed or not)
explicit declarations of the relations and data to be displayed, or by exclusion
templates
definition of the displayable data and relations (of those dedicated to the application)

### KEY TO THE FIGURES

FIG. 1

| | |
|---|---|
| Donnée | Data |
| nom_de_code: String valeur | code_name: Value string |
| Relation | Relation |

FIG. 2

| | |
|---|---|
| DefinitionDonnee | DataDefinition |
| DefinitionRelation | RelationDefinition |
| nom_de_code: String | code_name: Description |
| libelle: String type: | string: String type: |
| String unite: String | String unit: String |
| taille_max: Integer | size_max: Integer |
| nom_de_code: String | code_name: Description |
| libelle: String type: | string: String type: |
| String cardinalite: String | String cardinality: String |
| Donnée | Data |
| Relation | Relation |
| valeur | value |

FIG. 3

| | |
|---|---|
| Definition | Definition |
| id: int | id: int |
| espace_de_nom: String | name_space: String |
| nom_de_code: String | code_name: String |
| libelle: String | description: String |
| commentaire: String | comment: String |
| valider( ): void | validate( ): void |
| invalider( ): void | invalidate( ): void |
| enregistrer( ): void | record( ): void |
| DefinitionDonnee | DataDefinition |
| unite: String | unit: String |
| extremite | end |
| DefinitionRelation | RelationDefinition |
| DefinitionExtremiteRelation | RelationEndDefinition |
| extremite: char | end: char |
| navigable: Boolean | navigable: Boolean |
| TypeDonnee | DataType |
| longueur_chaine: int | string_length: int |
| classe_complexe: String | complex_class: String |
| Cardinalite | Cardinality |
| minimum: int | minimum: int |
| maximum: int | maximum: int |
| enumeration | list |
| EnmTypeDonnee | DataTypeList |
| vide | void |
| chaine | string |
| booléen | Boolean |
| entier | integer |
| flottant | floating |
| date | date |
| date_heure | date_time |
| complexe | complex |
| EnmVisibilite | VisibilityList |
| public | public |
| protege | protected |
| package | package |
| EnmTypeRelation | RelationTypeList |
| association | association |
| agrégation | aggregation |
| composition | composition |
| héritage | inheritance |

FIG. 4

| | |
|---|---|
| DefinitionDonnee | DataDefinition |
| unite: String | unit: String |
| extremite: char | end: char |
| navigable: Boolean | navigable: Boolean |
| DefinitionRelation | RelationDefinition |
| DefinitionExtremiteRelation | RelationEndDefinition |
| Donnee | Data |
| id: Integer | id: Integer |
| valeur | value |
| validee: Boolean | validated: Boolean |
| enregistree: Boolean | recorded: Boolean |
| valider( ): void | validate( ): void |
| enregistrer( ): Boolean | record( ): Boolean |
| supprimer( ): Boolean | delete( ): Boolean |
| ExtremiteRelation | RelationEnd |
| donnee_id: Integer | data_id: Integer |

FIG. 5

| | |
|---|---|
| interface | interface |
| iStockageAdaptateur | iStorageAdaptor |
| lire(id: Integer) | read(id: Integer) |
| lire_tout( ): void | read_all( ): void |
| ecrire(objet_pod): Boolean | write(object_pod): Boolean |
| supprimer(objet_pod): | delete(object_pod): Boolean |
| Boolean | |
| iStockageConnexion | iStorageConnection |
| ouvrir_connexion | open_connection |
| fermer_connexion | close_connection |
| executer_requete_pod | execute_request_pod |
| (requete_podql: String) | (request_podql: String) |
| iStockageAdaptateurDefinition | iStorageAdaptorDefinition |
| lire_tout_et_mettre_en_cache | read_all_and_put_in_cache |
| iStockageAdaptateur | iStorageAdaptor |
| DefinitionRelation | DefinitionRelation |
| iStockageAdaptateur | iStorageAdaptor |
| DefinitionDonnee | DefinitionData |
| iStockageAdaptateurRelation | iStorageAdaptorRelation |
| iStockageAdaptateurDonnee | iStorageAdaptorData |
| lire_selon_valeur | read_accordingto_value |
| lire_selon_valeur_liee | read_accordingto_value_linked |
| lire_selon_valeur | read_accordingto_value |
| lire_selon_requete | read_accordingto_request |
| (requete podql: String): Vector | (request podql: String): Vector |
| StockageUsine | PlantStorage |
| get_connexion | get_connection |
| creer_adaptateur_definition_donnee | create_adaptator_data_definition |
| (connexion . . .) | (connexion . . .) |
| lire_toutes_definitions( ): void | read_all_definitions( ): void |
| chaine_connexion: String) | connection_string: String |
| ouvrir_connexion | open_connection |
| fermer_connexion | close_connection |
| executer_requete_pod | execute_request_pod |
| (requete_podql: String) | (request_podql: String) |
| iStockageJeuResultats | iStorageGameResults |
| donnee_suivante( ): Donnee | next_data( ): Data |
| ligne_suivante( ): | next_line( ): |
| iStorageLigneResultat | iStorageLineResult |
| rembobiner | rewind |
| get_colonnes | get_columns |
| get_valeurs | get_values |
| get_valeur(nom_colonne: | get_value(column_name: |
| DefinitionDonnee): void | DataDefinition): void |

FIG. 6

| | |
|---|---|
| pod_exemple.donnees | pod_example.data |
| pod_exemple.relations | pod_example.relations |
| id: int | id: int |
| donnee | data |
| id: int | id: int |
| valeur: varchar | value: varchar |

FIG. 7

| | |
|---|---|
| contact | contact |
| nom | surname |
| prénom | name |
| société | company |
| téléphone | telephone |
| email | email |
| civilité | marital status |
| libellé | description |
| donnée Pod symbolisée par | Pod data item symbolized |
| son libellé | by its description |
| donnée | data (item) |
| les données A et B sont | data items A and B are |
| associée | associated |
| la donnée B est un élément | data item B is an element |
| de la donnée A | of data A |
| la donnée A est un agrégat | data item a is an |
| | aggregate |
| la donnée B est composant | data item B is a component |
| de la donnée A | of data A |
| la donnée A est un composé | data item A is a compound |
| A. données et relations | A. data and relations |
| modélisant un “contact” | modelling a “contact” |
| contact | contact |
| mariage | marriage |
| date | date |
| B. exemple d'une relation | B. example of a ternary |
| ternaire décrivant un | relation describing a |
| mariage entre 2 données | marriage between 2 |
| “contact” et une donnée | “contact” data items and |
| “date” | one “date” data item |

1. Process for recording a plurality of data items constituting at least one entity, wherein it includes:
a phase of creating a data definition for each data item of said plurality of data items;
a phase of creating a relation definition for at least one relation between at least two previously created data definitions;
a phase of creating each data item and relation of said plurality of data items;
a phase of recording each data item of said plurality of data items so that a recorded data item is associated with a corresponding data definition;
a phase of recording at least one relation so that a recorded relation corresponds to a relation definition and is associated with at least one previously recorded data item.

2. Process for recording a plurality of data items according to claim 1, wherein said phase of creating a relation definition includes, for a relation:
a step of creating a first relation end including a first relation cardinality and associated with a first data definition;
a step of creating a second relation end each including a cardinality of relation associated with a data definition.

3. Recording process according to claim 1, wherein a data definition includes:
a code name;
a type.

4. Recording process according to claim 1, wherein a relation definition includes:
a code name;
a type;
at least one end.

5. Device for recording a plurality of data items, comprising:
means for creating a data definition for each data item of said plurality of data items;
means for creating a relation definition for at least one relation between at least two previously created data definitions;
means for creating each data item and relation of said plurality of data items;
means for recording each data item of said plurality of data items so that a recorded data item is associated with a corresponding data definition;
means for recording at least one relation so that a recorded relation corresponds to a relation definition and is associated with at least one previously recorded data item.

6. Computer program that can be downloaded from a communication network and/or stored on a computer readable medium and/or run by a microprocessor, wherein it includes program code instructors for executing the recording process according to claim 1, when it is executed on a computer.
